(19) United States
(12) Patent Application Publication
(10) Pub. No.: US 2011/0109182 A1
(43) Pub. Date: May 12, 2011

(54) Magnetic transmission

(76) Inventor: Jozef Andrzej Maj, Lemont, IL (US)

(21) Appl. No.: 12/891,709

(22) Filed: Sep. 27, 2010

Related U.S. Application Data
(60) Provisional application No. 61/280,533, filed on Nov. 5, 2009.

(51) Int. Cl. H02K 49/10

(52) U.S. Cl. 310/103

(57) ABSTRACT

A magnetic transmission is provided for increasing or decreasing rotational speed as any transmission or reducer including those for cars and trucks. Since this transmission does not require oil, it will eliminate the need for a separate oil cooling system which is especially beneficial for electric cars, also design useful as an automatic automobile transmission or more generally as a momentum transfer device.

This Application claims priority from provisional patent application No. 61/280,533.

### BACKGROUND

1. Field of Invention

This invention covers a magnetic transmission design, useful as an automatic automobile transmission or more generally as a momentum transfer device.

2. Description of Prior Arts

Automatic automobile transmissions typically are complex, multipart devices that are expensive to manufacture and to maintain. Most current transmissions in general, include contacting parts that must be lubricated and are subject to wear induced failure.

All of the above mentioned equipment has a number of disadvantages, such as:
(a) expensive to manufacture
(b) expensive to maintain
(c) requires lubrication
(d) requires a cooling system
(e) subject to wear induced failure

### OBJECTS AND ADVANTAGES

Accordingly, several objects and advantages of the present invention are:
(a) this invention would simplify the design of automatic transmission
(b) reducing the number of component parts
(c) reduce cost of manufacture
(d) reduce cost of maintenance
(e) no contacting parts within the transmission
(f) increasing lifetime
(g) no oil required for operation or lubrication
(h) no cooling—oil or coolent—required
(i) this transmission will eliminate the necessity of disposing of used oil
(j) reducing pollution
(k) reduces wear on its components
(l) improves reliability

The invention “magnetic transmission” is very convenient which can be used not only on moving vehicles but also on stationary machines replacing belt driven transmissions.

### DESCRIPTION OF DRAWING (PICTURE)

The drawing shows elements of the model of the machine in sequential order.

FIG. 1 is a picture perspective view of the invention showing one of the version of the magnetic transmission; and

FIGS. 2 and 3 are a side view of the invention showing a version of the magnetic transmission with indirect wheel.

### REFERENCE NUMERALS IN DRAWINGS

A—permanent magnet
B—rotatable wheel
C—independently rotatable electrical conductive wheel
D—mechanical device
E—the mass
F—dependently rotatable electrical conductive wheel

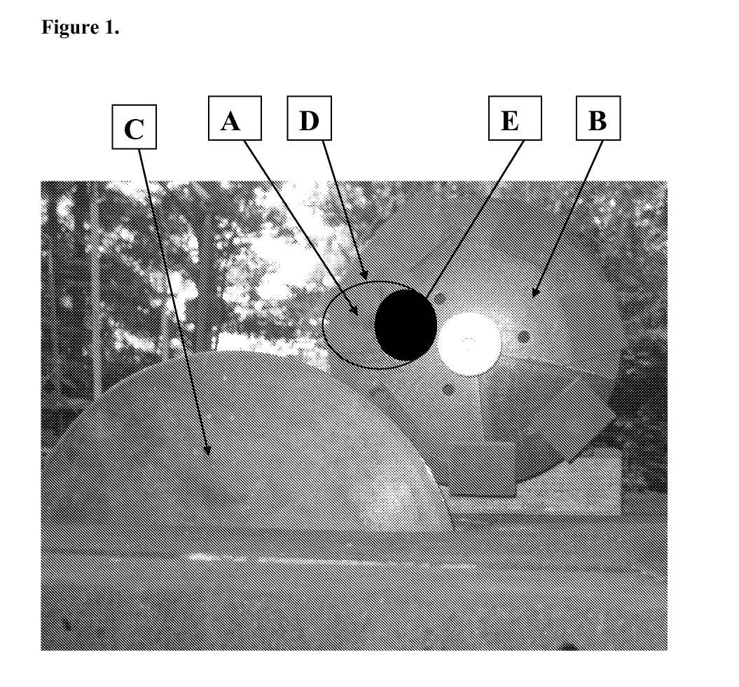

### Description—FIGS. 1, 2 and 3

A typical embodiment of the transmission of the present invention is illustrated in FIG. 1 (isometric view). Referring to the drawing on the following page, this invention is a magnetic transmission consisting of magnets “A” installed on rotatable wheel “B”. An independently rotatable electrical conductive wheel “C” (preferably made of copper). As the rotational speed of conductive wheel “C” increases the speed the magnets on “A” respond by increasing the speed of wheel “B”. The magnetic transmission can be constructed with several wheels with permanent magnets or electromagnets, as required.

The magnet “A” of the transmission can be installed in the device “D” which is designed to move along the radius of wheel “B” thereby increasing or decreasing its speed similar to automatic transmission. Magnet “A” can be biased outward by the force of a spring. As the rotational speed of wheel “B” increases the magnet “A” moves toward the center of the wheel. The mass of “E” is greater than the mass of magnet “A”, so that the rotational speed of the wheel “B” will move the mass “E” to the end of the radius and the magnet “A” will be forced closer to the center of the wheel “B”. This will increase the rotational speed of wheel “B”. The mechanical device “D” can be replaced by an electronic control system if the automatic transmission will need more precise parameters.

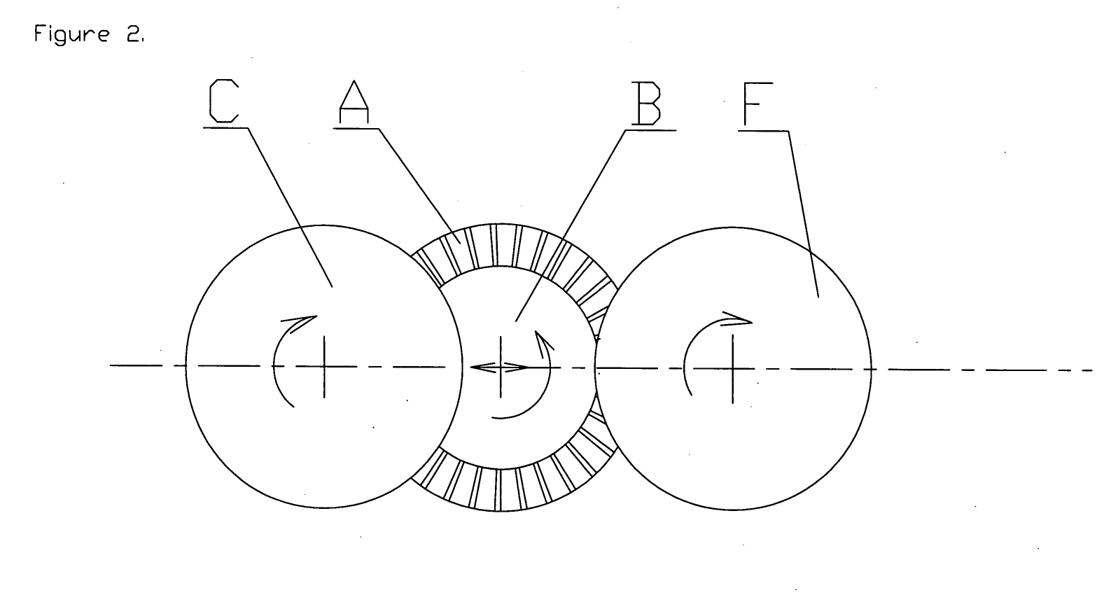

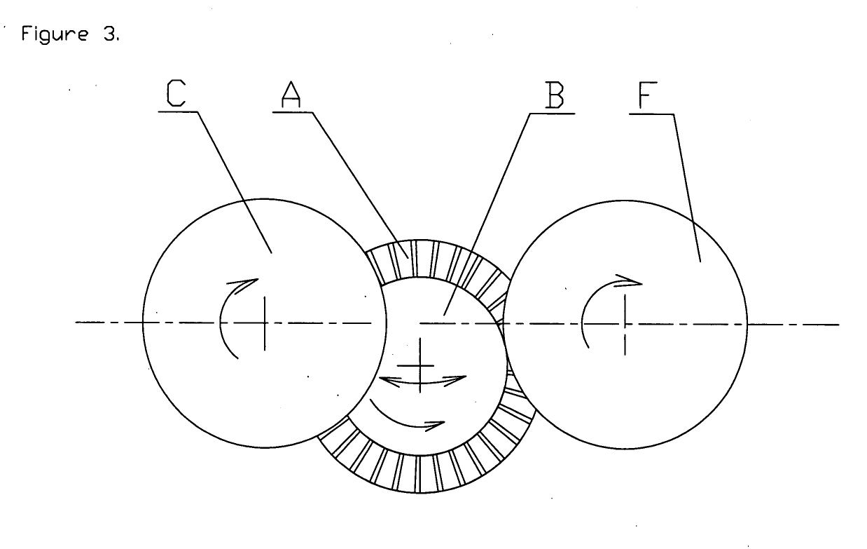

FIGS. 2 and 3 shows another version of the magnetic transmission which consists of indirect wheel “B”. The wheel “B” transfers momentum from the wheel “C” to the wheel “F”. While the wheel “C” of the transmission changing speed, the wheel “B” moves linearly or along a curve between wheels “C” and “F” as a result the rotatable speed of wheel “F” changes.

### Operation—FIGS. 1, 2 and 3

There are no magnetic transmissions used for this application at the present time. The operation of this invention can be summarize more clearly as combining the operational properties of an electrical generator and motor. In its most simple form, the invention consists of a circular copper plate connected via a shaft to a (power train motor or engine). Another circular wheel with permanent magnets mounted on its edges which would be connected to the wheels of an automobile, for example. If the copper plate is in a horizontal position, the support plate would be vertically displaced from it by approximately 1 mm. The shafts of the two plates would be offset from each other such that there was substantial overlap between the two.

The operation of the “magneto-electric transmission” begins as the copper plate begins to spin. As this occurs, the magnetic flux through a local section of the copper plate changes due to the relative motion of the permanent magnets on the support plate. This changing magnetic flux then creates a current in the copper plate similar to the operation of a generator. However, as the copper plate spins, the current that has been produced creates a magnetic field that now interacts with the magnetic field of the permanent magnets on the support plate thus creating a force on the support plate making the support plate spin faster—similar to the function of an electrical motor.

Improvements can be made in the design of the transmission by possibly using electrical coils instead on a conductive, copper disk since the momentum transfer between the plates is dependent on the magnitude of the current. The number and placement of magnets can be optimized, as well as the displacement and offset of the two disks. In addition, although my initial invention disclosure described operation with two plates, any number of plates can be used depending on the application and load on the transmission.

Another important feature of the invention is that the effective moment of inertia of the supporting plate can be modified automatically during operation. This is implemented by allowing the magnet to rotate inward toward the center of the support plate. This will reduce the moment of inertia of the support plate, allowing it to spin faster for high speed operation—important for operation as an automatic transmission. It is referred to this additional device as “D” in the drawings.

### Summary, Ramification, and Scope

Accordingly, the magnetic transmission of this invention can be used as any transmission or reducer. This discovery may be applied to many different types of transmissions including those for cars and trucks. Since this transmission does not require oil, it will eliminate the need for a separate oil cooling system which is especially beneficial for electric cars. Also, the design is useful as an automatic automobile transmission or more generally as a momentum transfer device.

A company that would be interested in this invention includes any company that designs vehicles for transportation, farming, construction, recreation, and military applications, including those in alternate energy generation who may benefit from this technology.

Although the above description contains many specifities, these should not be construed as limiting in scope of this invention, but as merely providing illustrations of some of the presently preferred embodiments of this invention.

Thus the scope of the invention should be determined by the appended claims and their legal equivalents, rather than by the examples given.

1. A transmission for transferring rotational power from an input shaft to an output shaft, said transmission comprising:
a first wheel drivingly connected to one of said input shaft and said output shaft,
said first wheel having a first radius and rotatable about a first axis.
a plurality of magnets spaced around a circumference of said first wheel,
a second wheel drivingly connected to the other of said input shaft and said output shaft,
said second wheel being electrically conductive but not magnetically conductive,
said second wheel having a second radius and rotatable about a second axis parallel to said first axis and spaced from said first axis by a distance less then the combined length of said first radius and said second radius,
said second wheel having a surface spaced a short distance from a surface of said first wheel wherein rotation of said first wheel cause eddy current in said second wheel and thereby applies rotational force to said second wheel.

2. The transmission of clam 1 wherein one of said first and second axis is moveable toward and away from said other of said first and second axis wherein movement toward said other of said first and second axis causes said second wheel to rotate more rapidly with respect to said first wheel and movement away from said other of said first and second axis causes said second wheel to rotate less rapidly with respect to said first wheel.

3. The transmission of claim 1 and further comprising a third wheel rotatable about said first axis and spaced from said first wheel,
a portion of said second wheel boxing between said first wheel and said third wheel, and
said third wheel having a plurality of magnets spaced around a circumference thereof.

4. The transmission of claim 1 and further comprising a third wheel rotatable about said second axis and spaced from said second wheel,
a portion of said first wheel passing between said second wheel and said third wheel, and
said third wheel being electrically conductive but not magnetically conductive.

5. The transmission of claim 1 wherein said first axis is movable toward and away from said second axis to thereby change a rotational speed of said second wheel with respect to rotational speed of said first wheel.

6. The transmission of claim 1 and further comprising
a plurality of spaced apart identical first wheels mounted on a first axle rotatable said first axis and a second plurality of spaced apart identical second wheels mounted on a second axle rotatable about said second axis with an other each ones of said first wheels portioned between other each of two apparent second wheels.

7. A transmission for transferring rotational power from an input shaft to an output shaft, said transmission comprising,
a first wheel having a first radius, being rotatable about a first axis and drivingly connected to said input shaft,
a second wheel having a second radius, being rotatable about a second axis and drivingly connected to said output shaft,
a third wheel having a third radius and rotatable about a third axis,
said first, second and third axis all being parallel to each other,
said first axis spaced from said second axis a distance greater than the sum of said first radius and said second radius,
said first and second wheel being electrically conductive but not magnetically conductive,
a plurality of magnets spaced around circumference of said third wheel,
a first portion of a surface of said third wheel spaced a short distance from a portion of said first wheel and a second portion of a surface of said third wheel spaced a short distance from a portion of said second wheel wherein rotation of said first wheel with said input shaft cause the formation of eddie currents in said first wheel and applies rotational force to said third wheel, and rotation of said third wheel causes the formation of eddie currents in said second wheel and applies rotational forces thereto thereby causing rotation of said output shaft.

8. The transmission of claim 7 wherein said third axis is movable in a first direction toward said first axis and away from said second axis wherein a speed of said second wheel is decreased with respect to a speed of said first wheel, and movable in a second direction toward said second axis and away from said first axis wherein a speed of said second wheel is increased with respect to a speed of said first wheel.

9. The transmission of claim 7 and further comprising a first plurality of spaced apart identical first wheels mounted on a first axle rotatable about said first axis, a second plurality of spaced apart identical second wheels mounted on a second axle rotatable about said second axis and a third plurality of spaced apart identical third wheels mounted on a third axle rotatable about said third axis.
